(19) United States
(12) Patent Application Publication
(10) Pub. No.: US 2013/0143630 A1
(43) Pub. Date: Jun. 6, 2013

(54) Apparatus for the dissipation of emitting radiations from communication devices

(71) Applicant: Peter Joseph Krenzer, Palm Beach Gardens, FL (US)

(72) Inventor: Peter Joseph Krenzer, Palm Beach Gardens, FL (US)

(21) Appl. No.: 13/707,503

(22) Filed: Dec. 6, 2012

Related U.S. Application Data
(60) Provisional application No. 61/567,423, filed on Dec. 6, 2011.

(51) Int. Cl. H04M 1/02

(52) U.S. Cl. CPC H04M 1/0254
USPC 455/575.5

(57) ABSTRACT

An apparatus for the dissipation of emitting radiations from a communication device or any other radiation emitting devices by meeting or exceeding manufactures specifications includes a radiation dissipation body, an audio passage, a radiation dissipation distance, and an attachment mechanism. The radiation dissipation body includes an ear side, a lateral wall, and a speaker side. The ear side and the speaker side are oppositely positioned from each other and the lateral wall is positioned around the ear side and the speaker side. The attachment mechanism is positioned below the speaker side, and the audio passage is traversed through the ear side and the speaker side. The radiation dissipation distance extends from the ear side to the speaker side where the radiation dissipation distance meets or exceeds the manufactures specifications.

The current application claims a priority to the U.S. Provisional Patent application Ser. No. 61/567,423 filed on Dec. 6, 2011.

### FIELD OF THE INVENTION

The present invention relates generally to an apparatus for safely using a communication device. More specifically, the apparatus effectively provides a safe distance between the user's head and a communication device to reduce the effects of radiation from the communication device.

### BACKGROUND OF THE INVENTION

A cell phone has become an essential tool in the life of many people. With the adaption of the internet, cell phones have evolved from just simply making phone calls to being able to surf the web, chat, listen to music, write emails, and much more. With the introduction of these improvements comes a need for stronger and more powerful cell phones. However, these stronger and more powerful cell phones typically put out a lot of Radio Frequency (RF) that can be harmful to the user. Cell phone manufacturers now recommend minimum distances away from user's bodies. Examples include, but are not limited to, Apple iPhone 4=⅝ inch, Blackberry Curve 9330=0.98 inch, LG G2XO=0.79 inch, Casio G'z One Commando=0.79 inch, Pantech Caper=0.79 inch, HTC Thunderbolt=1 cm, Sony Ericsson Xperia X10=⅝ inch, Motorola ATRIX=1 inch, Kyocera Echo=0.886 inch, Samsung Galaxy S4G=1.5 cm. However, manufacturers have not provided an affordable safety option. Lyon, France, May 31, 2011—The WHO (World Health Organization) IARC (International Agency for Research on Cancer) has classified radio frequency electromagnetic fields as possibly carcinogenic to humans (Group 2B), based on an increase risk for glioma, a malignant type of brain cancer, associated with wireless phone use. Along with the recent increased number of thin phones in use by the general population follow the manufacturer's recommendations to keep phones at least ⅝ inch to 1 inch away from the body.

It is therefore an object of the present invention to introduce an apparatus that allows the user to talk on the cell phone or use other communication devices while maintaining a safe distance from the radiation emitted from the cell phone and the communication devices. The present invention is useful for the public concerned with health and safety using cell phones and communication devices. The present invention allows parents to be relieved in knowing that their children who use the disclosed apparatus will also be meeting manufacturer's standards for safety. The present invention also allows users to talk privately and safely without having to use speaker phone options.

### BRIEF DESCRIPTION OF THE DRAWINGS

FIG. 1 is a front perspective view of the preferred embodiment of the present invention.

FIG. 2 is a front view of the preferred embodiment of the present invention.

FIG. 3 is a right side view of the preferred embodiment of the present invention.

FIG. 4 is a detail view of an attachment mechanism of the preferred embodiment of the present invention.

FIG. 5 is a front view of the preferred embodiment of the present invention without the attachment mechanism.

FIG. 6 is a left side view of the preferred embodiment of the present invention.

FIG. 7 is a cross section view of the FIG. 6.

FIG. 8 is a perspective view of the preferred embodiment of the present invention, wherein the preferred embodiment is attached with a cell phone.

FIG. 9 is a perspective view of the first alternative embodiment of the present invention.

FIG. 10 is a front perspective view of the first alternative embodiment of the present invention.

FIG. 11 is a front view of the first alternative embodiment of the present invention.

FIG. 12 is a cross section view of the FIG. 11.

FIG. 13 is a top view of the first alternative embodiment of the present invention.

FIG. 14 is a perspective view of the first alternative embodiment in a closed position and illustrating an attachment mechanism.

FIG. 15 is a perspective view of the first alternative embodiment in an opened position and illustrating the attachment mechanism.

FIG. 16 is a perspective view of the first alternative embodiment in a flip-up position and illustrating the attachment mechanism.

FIG. 17 is a perspective view of the first alternative embodiment in a flip-up locked position and illustrating the attachment mechanism.

FIG. 18 is a front perspective view of the second alternative embodiment of the present invention.

FIG. 19 is a top view of the second alternative embodiment of the present invention.

FIG. 20 is side view of the second alternative embodiment of the present invention.

FIG. 21 is a cross section view of the FIG. 20.

FIG. 22 is a perspective view of the second embodiment of the present invention in a vertical position and illustrating an attachment mechanism.

FIG. 23 is a perspective view of the second embodiment of the present invention in a horizontal position and illustrating the attachment mechanism.

### DETAIL DESCRIPTIONS OF THE INVENTION

All illustrations of the drawings are for the purpose of describing selected versions of the present invention and are not intended to limit the scope of the present invention.

The present invention allows a user to meet manufacturer's suggested distances away from the body by placing the present invention over a communication device speaker to increase the distance between the communication device and the user's body. The manufacturer's suggested distance is the minimum distance required for a communication device, such as cell phone, land phone, two-way radio transceiver, or any other type of radiation emitting device, so that the communication device can be safely used without dangerously exposing users to radiation. The present invention comprises a radiation dissipation body 1 that can be a cone, elongated oval, circular, rounded, square, rectangle, or any other desired shape. The present invention embodies any shape, even matching the shape of the communication device. The manufacturer's suggested distances can be different from one communication device to another; therefore, the present invention comprises a radiation dissipation distance 3 in order to compensate for the different manufacturer's suggested distances. The present invention comprises an audio passage 2 which allows a communication device speaker to channel the sound to the user's ear at the manufacturer's suggested distance. The present invention can be fitted as an accessory on a communication device or incorporated into a new communication device as a standard component during the manufacturing phase. In order for the present invention to be attached on a communication device as the accessory, the present invention comprises an attachment mechanism 4. Since the present invention has no electronic components, the present invention can't be failed due to any electrical issues. The present invention can be made from, but is not limited to, memory foam, hard or soft plastic, metal, wood, or any other type of material of combination thereof.

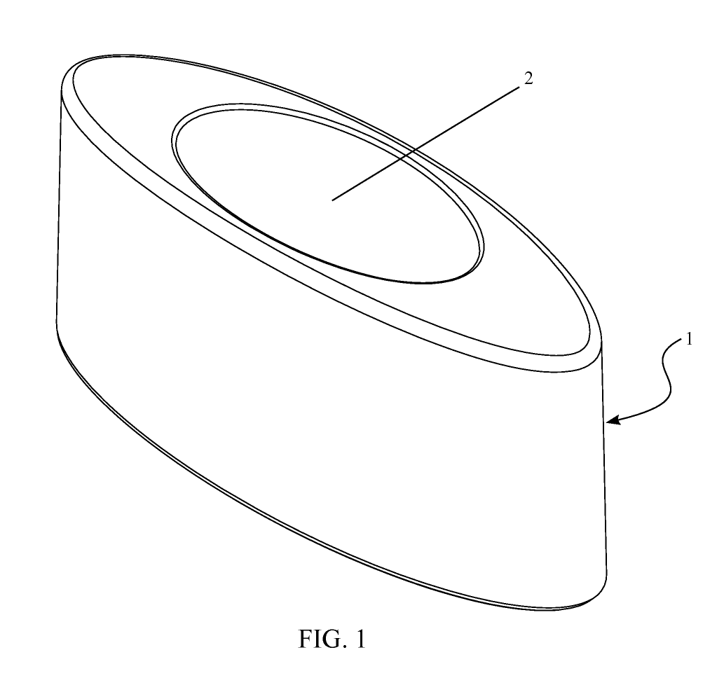

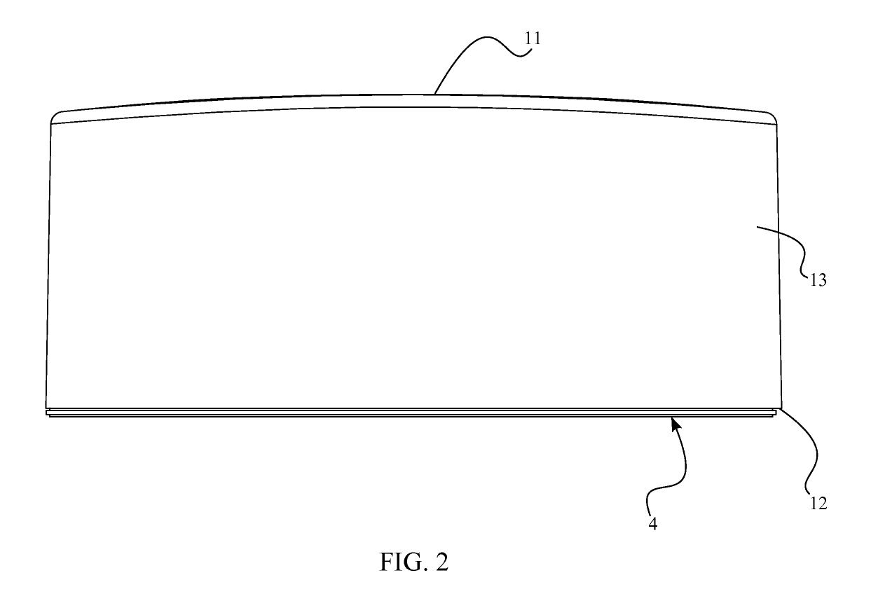

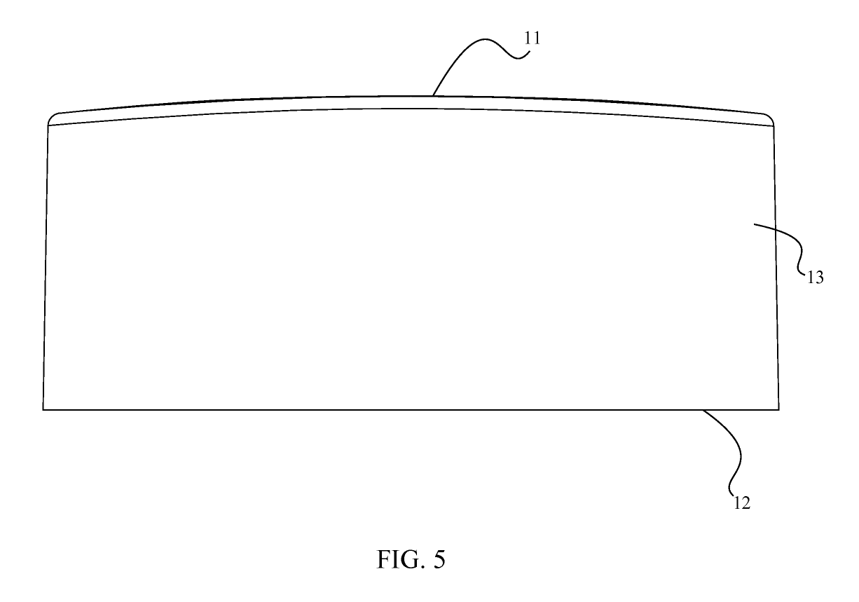

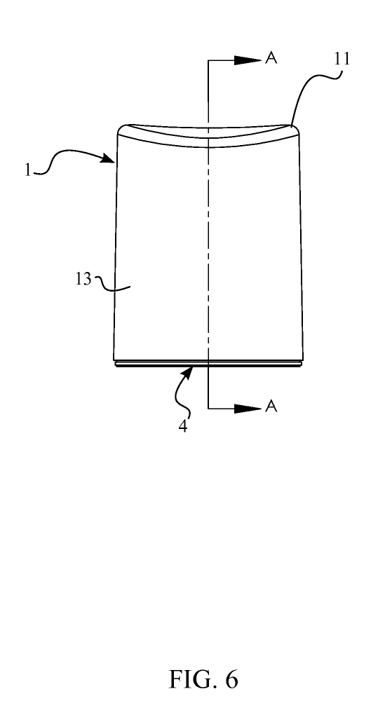

In reference to FIG. 1, FIG. 2, FIG. 5, and FIG. 6, the preferred embodiment of the present invention comprises the radiation dissipation body 1, the audio passage 2, the radiation dissipation distance 3, and the attachment mechanism 4. The radiation dissipation body 1 comprises an ear side 11, a speaker side 12, and a lateral wall 13. The radiation dissipation body 1 of the preferred embodiment is shaped into an elongated oval form. The ear side 11 and the speaker side 12 are oppositely positioned from each other, where the lateral wall 13 is perimetrically positioned in between the ear side 11 and the speaker side 12. The speaker side 12 is shaped into a flat surface which allows the speaker side 12 to firmly align with a communication device. The ear side 11 is shaped into an upside side truncated paraboloid surface so that the users of the preferred embodiment can comfortably lay the ear side 11 up against their ears.

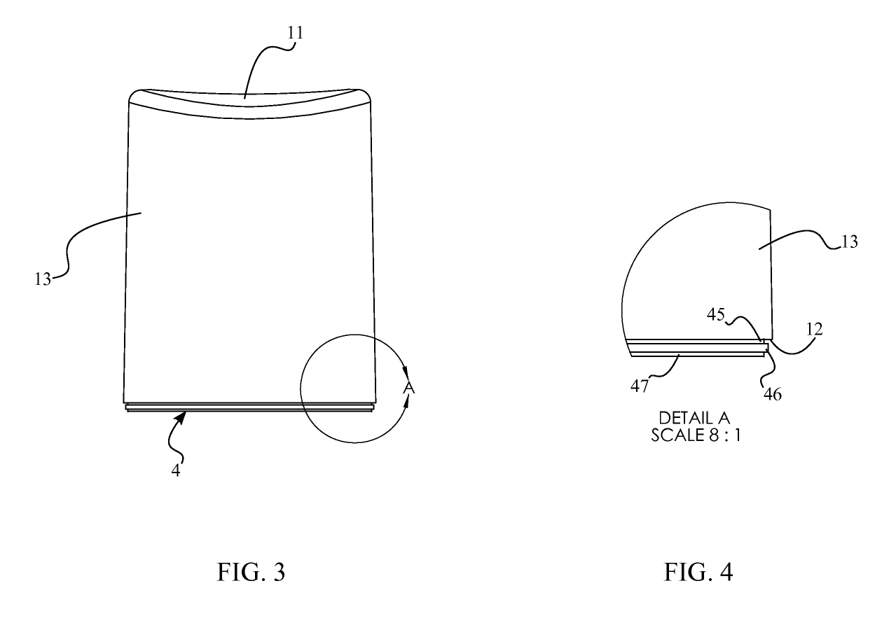

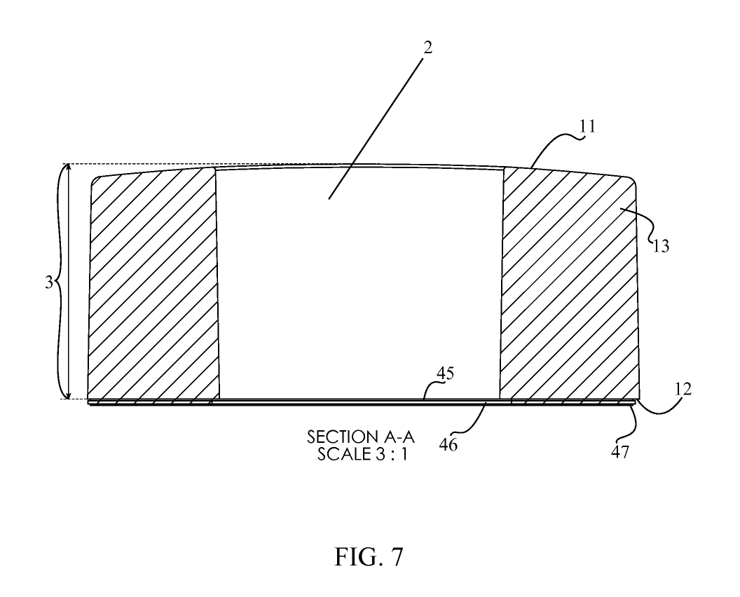

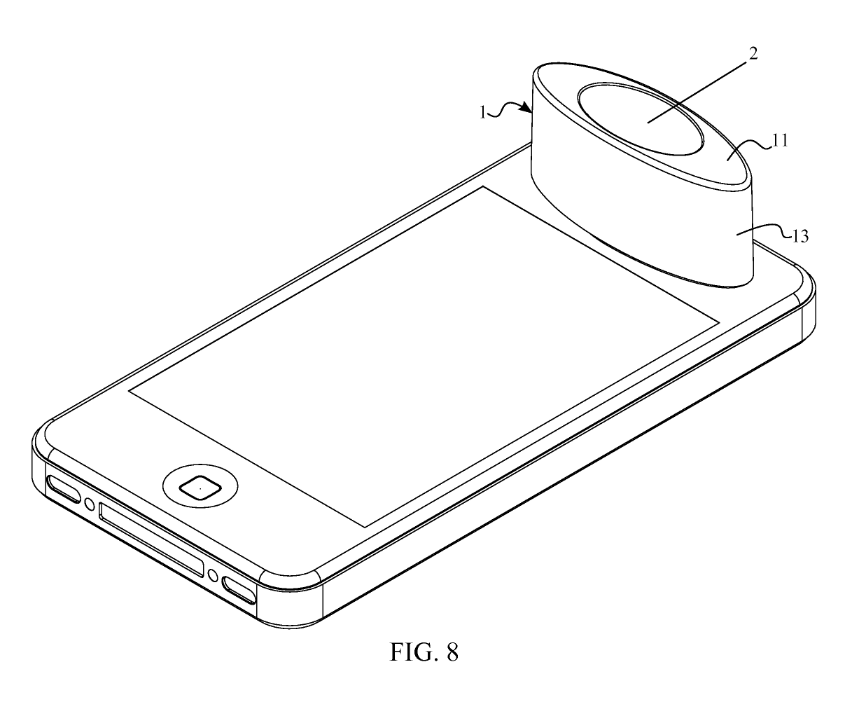

In reference to FIG. 3, FIG. 4, and FIG. 7, the audio passage 2 of the preferred embodiment is concentrically traversed through the ear side 11 to the speaker side 12. The radiation dissipation distance 3 of the preferred embodiment extends from the ear side 11 to the speaker side 12 along the audio passage 2. The attachment mechanism 4 of the preferred embodiment is positioned below the speaker side 12 and comprises a first adhesive layer 45, a flexible middle layer 46, and a second adhesive layer 47. The first adhesive layer 45 and the second adhesive layer 47 are oppositely connected to the flexible middle layer 46. The first adhesive layer 45 is hermetically attached to the speaker side 12, and the second adhesive layer 47 is hermetically attached around a communication device speaker. The attachment mechanism 4 of the preferred embodiment has a similar shape as the speaker side 12 so that the speaker side 12 can be fully attached to a communication device without any gaps or openings.

Since different communication device manufactures requires different manufacturer's suggested distances, the radiation dissipation distance 3 in the preferred embodiment can be varied, where the distance between the speaker side 12 and the ear side 11 are adjusted according to the manufacturer's suggested distances. In reference to FIG. 8, when the preferred embodiment is used within a communication device, audio sounds from a communication device speaker are channeled through the audio passage 2 to the user's ear. The radiation dissipation body 1 and the attachment mechanism 4 of the preferred embodiment prevent outside noise from getting into the audio passage 2 resulting an improved audio sound quality. Since the ear side 11 comfortably fits up against the user's ear, the audio passage 2 provides a direct and clear path so that the improved audio sound can travel without any distortions. The radiation dissipation body 1 of the preferred embodiment is made from fast recovery memory foam materials so that the radiation body can quickly recover from any deformed shapes to an initial shape within a short amount of time. For example, when the preferred embodiment is attached to a cell phone, and the cell phone is stored in a pocket of user's clothing article, the radiation dissipation body 1 can be deformed due to the variable pressure points. Due to the fast recovery memory foam materials, the radiation dissipation body 1 quickly changes into the initial shape of the preferred embodiment once the preferred embodiment is pulled out from the pocket. The fast recovery memory foam material comprises a smooth outer layer so that the radiation dissipation body 1 can be easily cleaned for sanitary purposes. The smooth outer layer also keeps the radiation dissipation body 1 clean without any buildups and germs.

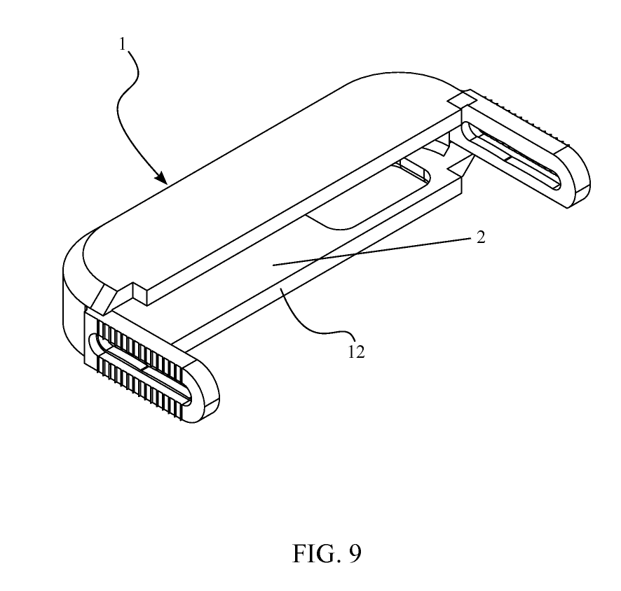

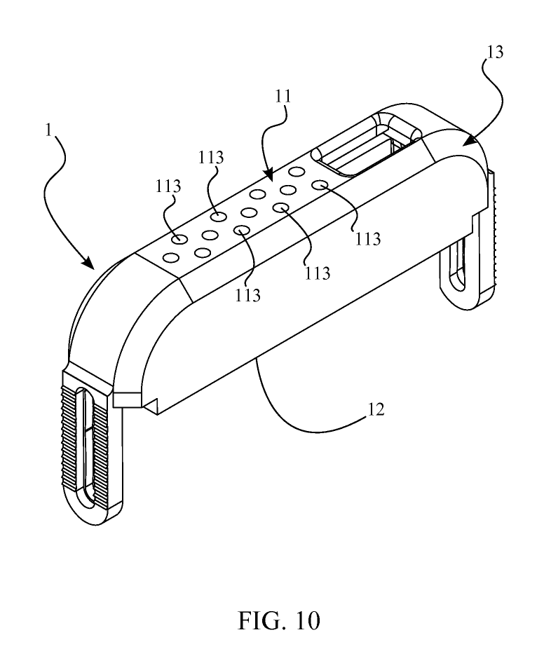

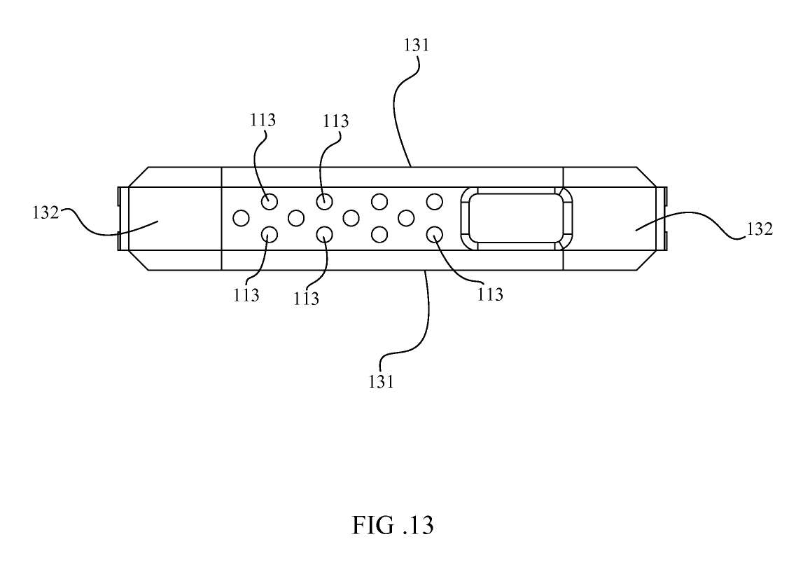

In reference to FIG. 9, FIG. 10, and FIG. 13, a first alternative embodiment of the present invention comprises the radiation dissipation body 1, the audio passage 2, the radiation dissipation distance 3, and the attachment mechanism 4. The radiation dissipation body 1 comprises an ear side 11, a speaker side 12, and lateral walls 13 where the lateral walls 13 comprise a pair of compact walls 132 and a pair of elongated walls 131. The radiation dissipation body 1 of the first alternative embodiment is shaped into a rectangular form. The ear side 11 and the speaker side 12 are oppositely positioned from each other, where the lateral walls 13 are perimetrically positioned in between the ear side 11 and the speaker side 12. The pair of compact walls 132 is oppositely positioned from each other, and the pair of elongated walls 131 is also oppositely positioned from each other and perpendicularly positioned with the pair of compact walls 132. The pair of elongated walls 131 and the pair of compact walls 132 are perimetrically connected to the ear side 11 and the speaker side 12. The speaker side 12 is shaped into a flat surface which allows the speaker side 12 to firmly align with a communication device. The ear side 11 is shaped into a flat surface so that the users of the first alternative embodiment can firmly position the ear side 11 up against their ears.

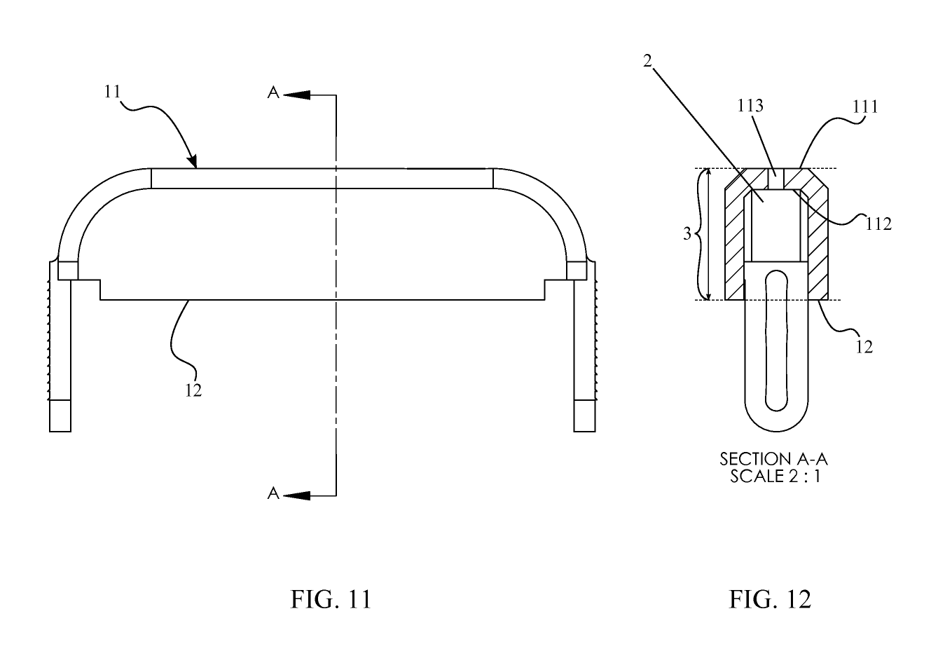

In reference to FIG. 11 and FIG. 12, the ear side 11 of the first alternative embodiment comprises an exterior plane 111, an interior plane 112, and a plurality of holes 113. The exterior plane 111 is adjacently positioned within the pair of compact walls 132 and the pair of elongated walls 131. The interior plane 112 is positioned parallel with the exterior plane 111 and in between the exterior plane 111 and the speaker side 12. The audio passage 2 of the first alternative embodiment is concentrically traversed from the speaker side 12 to the interior plane 112. The plurality of holes 113 is traversed from the exterior plane 111 to the interior plane 112 where the plurality of holes 113 extends into the audio passage 2. The radiation dissipation distance 3 of the first alternative embodiment extends from the ear side 11 to the speaker side 12 through the audio passage 2 and the plurality of holes 113.

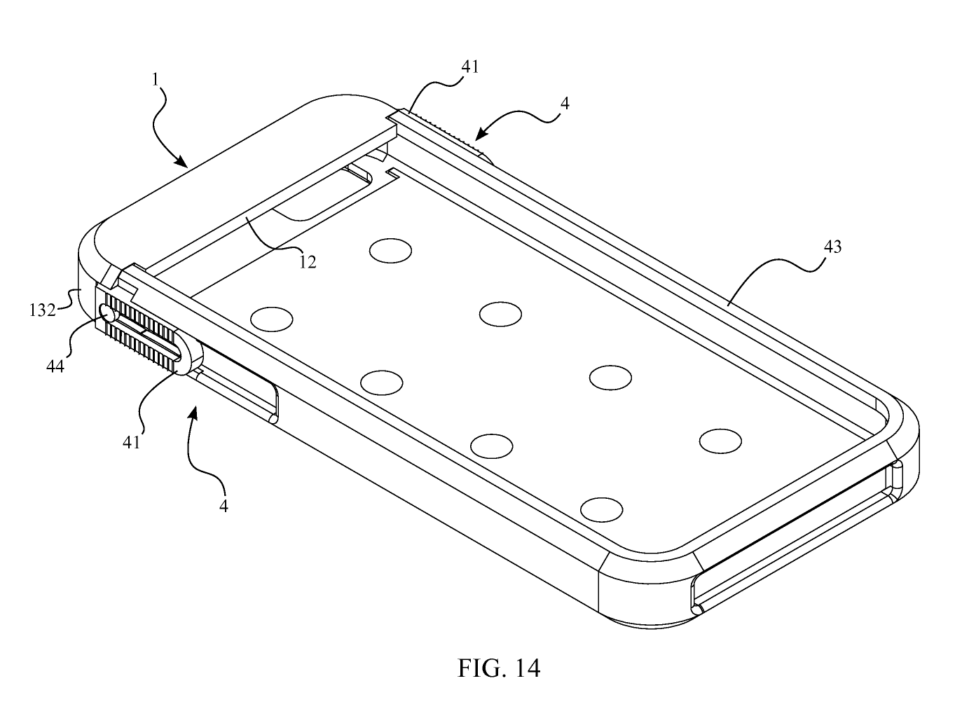

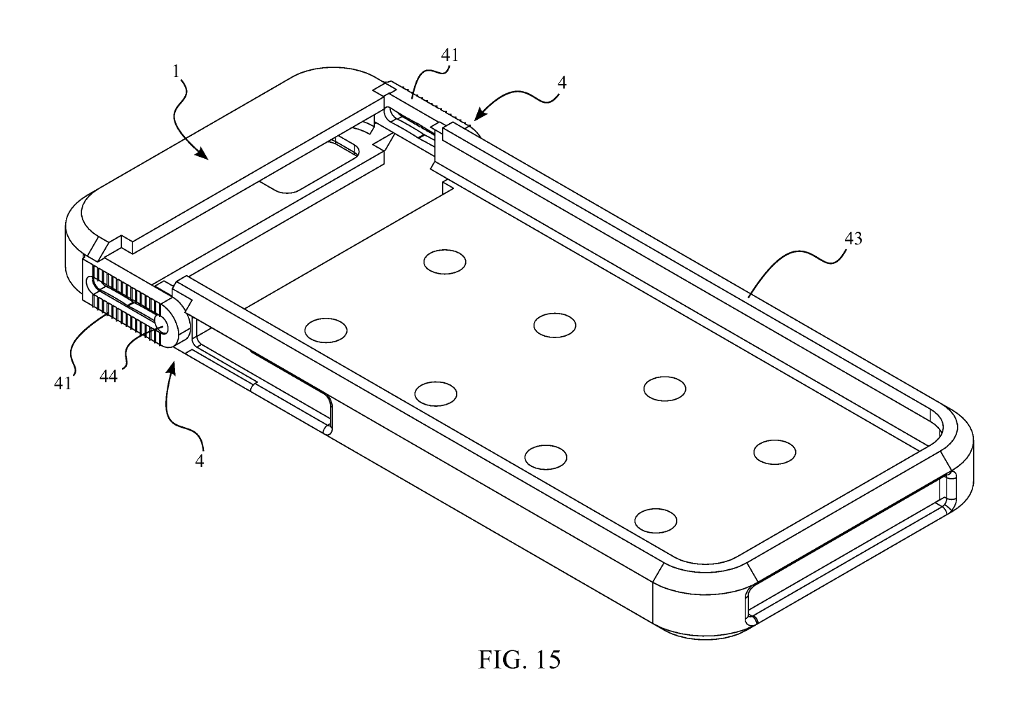

In reference to FIG. 14, the attachment mechanism 4 of the first alternative embodiment is positioned below the speaker side 12 and comprises a pair of tapered tracks 41, a lower position case 43, and a pair of track protrusions 44. The pair of tapered tracks 41 is oppositely positioned from each other and perpendicularly positioned with the speaker side 12. Each of the tapered tracks 41 comprises a narrow end and wider end.

The narrow ends are positioned adjacent with the speaker side 12. The wider ends are linearly positioned with the narrow ends and positioned away from the speaker side 12. The pair of tapered tracks 41 is adjacently connected with the pair of compact walls 132. The lower position case 43 functions as a communication device case where the lower position case 43 is partially placed around a communication device. The pair of track protrusions 44 is linearly aligned with the pair of tapered tracks 41 and oppositely positioned on the lower position case 43. Each of track protrusions 44 is shaped into a cylindrical body where the cylindrical body is perpendicularly connected with the lower position case 43. In order to attach the radiation dissipation body 1 of the first alternative embodiment, the pair of track protrusions 44 is movably inserted into the pair of tapered tracks 41.

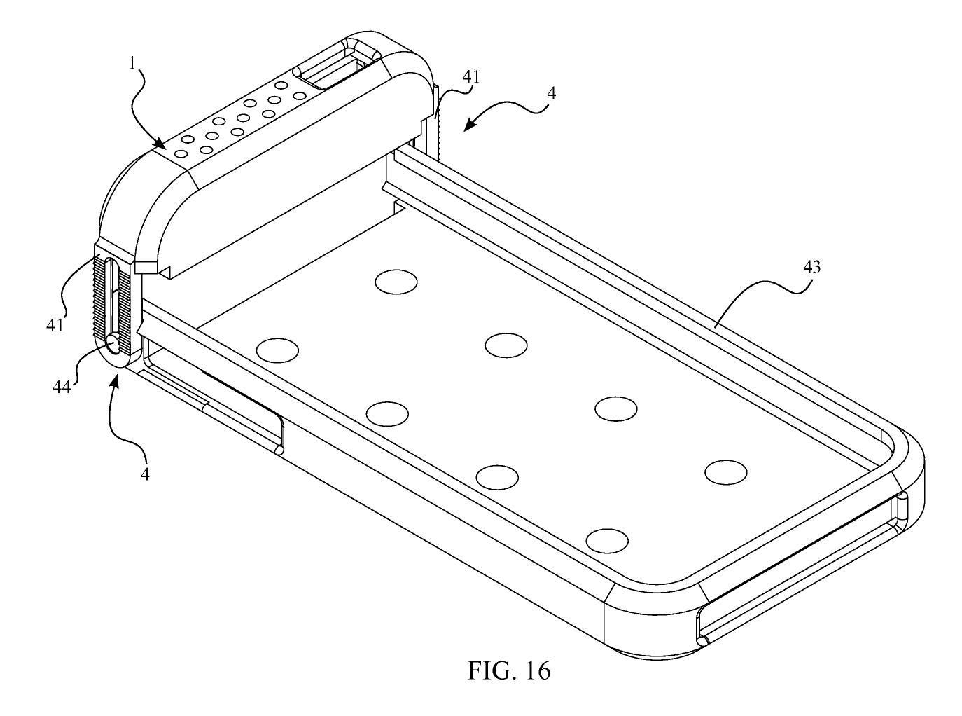

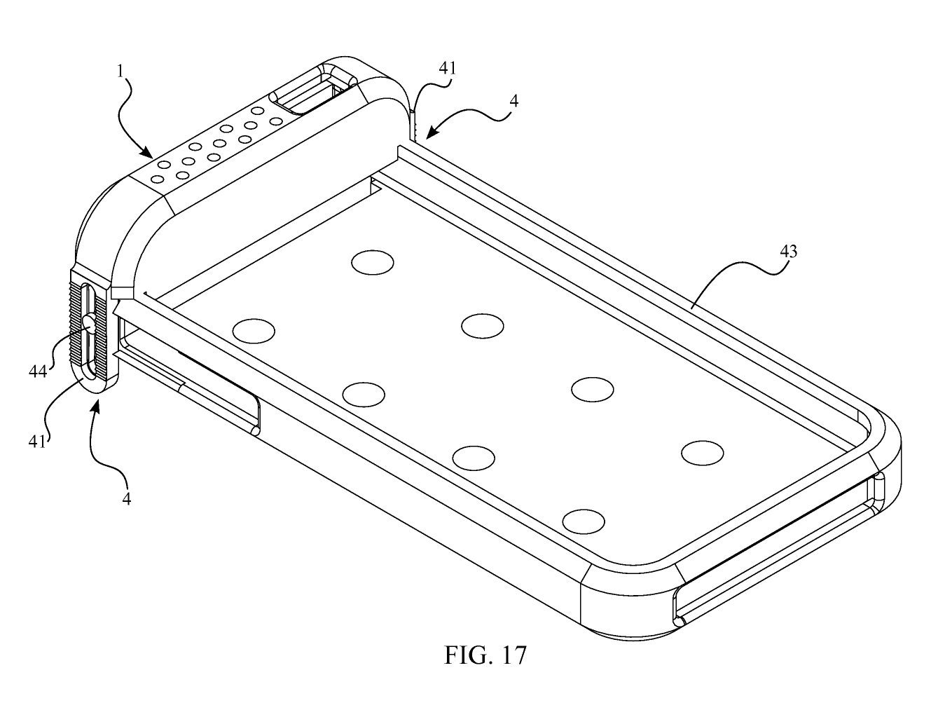

The attachment mechanism 4 of the first alternative embodiment further comprises a closed position, an opened position, a flip-up position, and a flip-up locked position. In reference to FIG. 14, the closed position securely places the radiation dissipation body 1 aligned with the lower position case 43 when the communication device is not used by the user. When the narrow ends are adjacently positioned with the pair of track protrusions 44, and the radiation dissipation body 1 is linearly aligned with the lower position case 43, the first alternative embodiment is positioned at the closed position. When the user needs to use the communication device, the attachment mechanism 4 is changed from the closed position to the flip-up locked position in order to attain the radiation dissipation distance 3 within the first alternative embodiment. As shown in FIG. 15, the radiation dissipation body 1 is pulled out until the wider ends are adjacently positioned with the pair of track protrusions 44 allowing the first alternative embodiment to change into the opened position from the closed position. In reference to FIG. 16, then the radiation dissipation body 1 is rotated 90 degrees clockwise toward a front side of the communication device and perpendicularly aligned with the lower position case 43, where the first alternative embodiment changes from the opened position to the flip-up position. When the first alternative embodiment is at the flip-up position, the wider ends are adjacently positioned with the pair of track protrusions 44. In reference to FIG. 17, finally the radiation dissipation body 1 is pushed down along the pair of tapered tracks 41 until the narrow ends are adjacently positioned with the pair of track protrusions 44, where the attachment mechanism 4 is changed from the flip-up position to the flip-up locked position. Since the narrow ends tightly fit around the pair of track protrusions 44, and the radiation dissipation body 1 firmly positions perpendicular with the communication device, the speaker end is adjacently positioned around a speaker of the communication device. Once the user has finished using the communication device, the user can change the attachment mechanism 4 from the flip-up locked position to the closed position so that the communication device can be stored away.

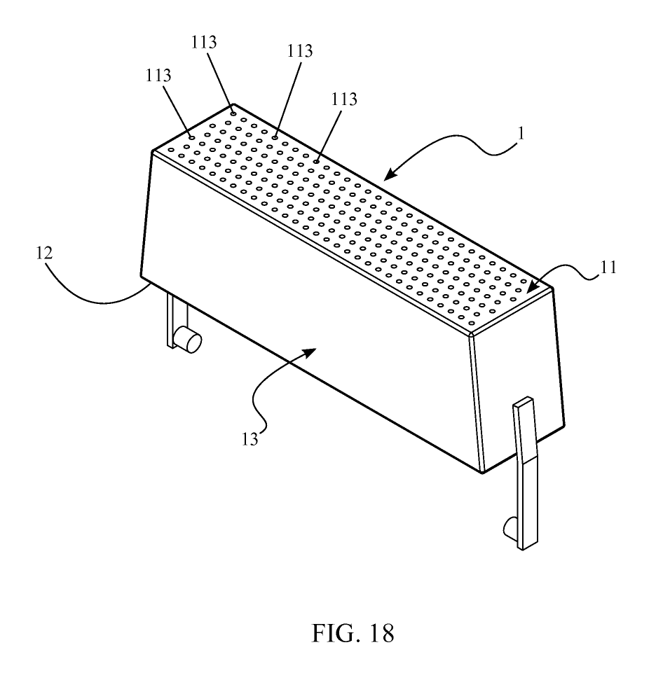

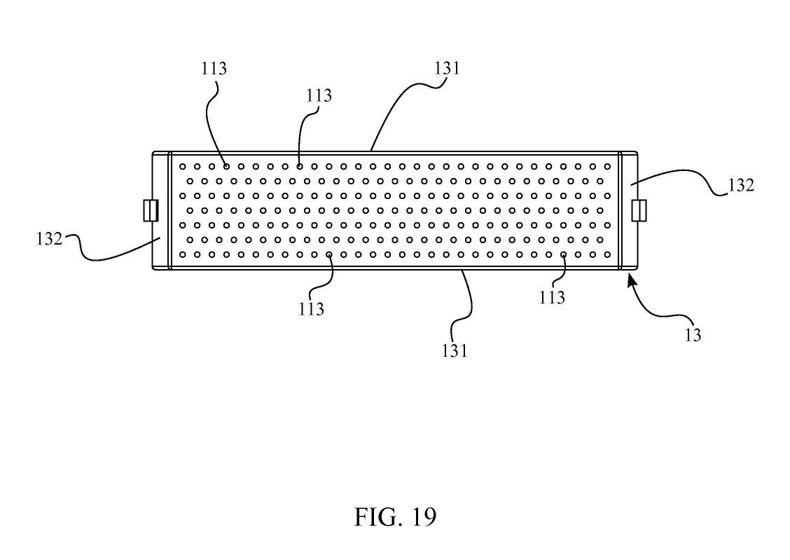

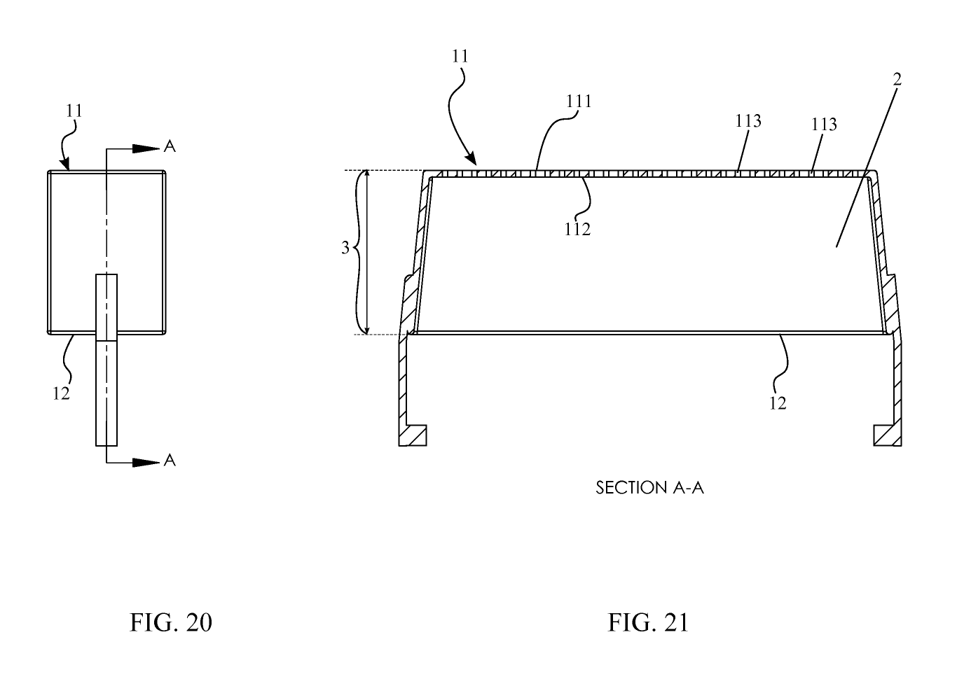

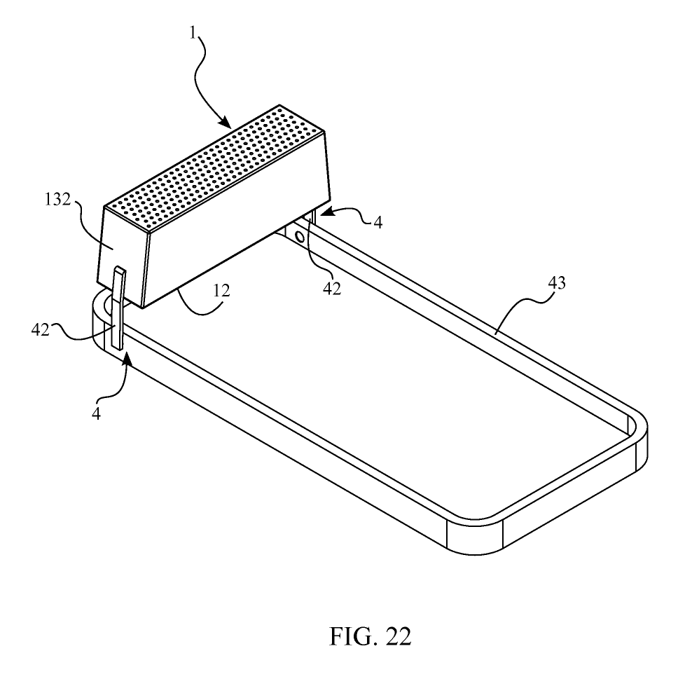

In reference to FIG. 18 and FIG. 19, a second alternative embodiment of the present invention comprises the radiation dissipation body 1, the audio passage 2, the radiation dissipation distance 3, and the attachment mechanism 4. The radiation dissipation body 1 comprises an ear side 11, a speaker side 12, and lateral walls 13 where the lateral walls 13 comprise a pair of compact walls 132 and a pair of elongated walls 131. The radiation dissipation body 1 of the second alternative embodiment is shaped into a rectangular form. The ear side 11 and the speaker side 12 are oppositely positioned from each other, where the lateral walls 13 are perimetrically positioned in between the ear side 11 and the speaker side 12. The pair of compact walls 132 is oppositely positioned from each other, and the pair of elongated walls 131 is also oppositely positioned from each other and perpendicularly positioned with the pair of compact walls 132. The pair of elongated walls 131 and the pair of compact walls 132 are perimetrically connected to the ear side 11 and the speaker side 12. The speaker side 12 is shaped into a flat surface which allows the speaker side 12 to firmly align with a communication device. The ear side 11 is also shaped into a flat surface so that the users of the second alternative embodiment can firmly position the ear side 11 up against their ears. In reference FIG. 20 and FIG. 21, the ear side 11 of the second alternative embodiment comprises an exterior plane 111, an interior plane 112, and a plurality of holes 113. The exterior plane 111 is adjacently positioned within the pair of compact walls 132 and the pair of elongated walls 131. The interior plane 112 is positioned parallel with the exterior plane 111 and in between the exterior plane 111 and the speaker side 12. The audio passage 2 of the second alternative embodiment is concentrically traversed from the speaker side 12 to the interior plane 112. The plurality of holes 113 is traversed from the exterior plane 111 to the interior plane 112 where the plurality of holes 113 extends into the audio passage 2. The radiation dissipation distance 3 of the second alternative embodiment extends from the ear side 11 to the speaker side 12 through the audio passage 2 and the plurality of holes 113.

In reference to FIG. 22, the attachment mechanism 4 of the second alternative embodiment is positioned below the speaker side 12 and comprises a pair of extension arms 42 and a lower position case 43. The pair of extension arms 42 is oppositely positioned from each other and perpendicularly positioned with the speaker side 12. Each of the extension arms 42 comprises a fixed end and a pivotable end. The fixed ends are positioned adjacent with the speaker side 12. The pivotable ends are linearly positioned with the fixed ends and positioned away from the speaker side 12. The fixed ends are adjacently connected with the pair of compact walls 132. The lower position case 43 functions as a communication device case where the lower position case 43 is partially placed around a communication device. In order to attach the radiation dissipation body 1 of the second alternative embodiment to the lower position case 43, the pivotable ends are rotatably inserted into the lower position case 43.

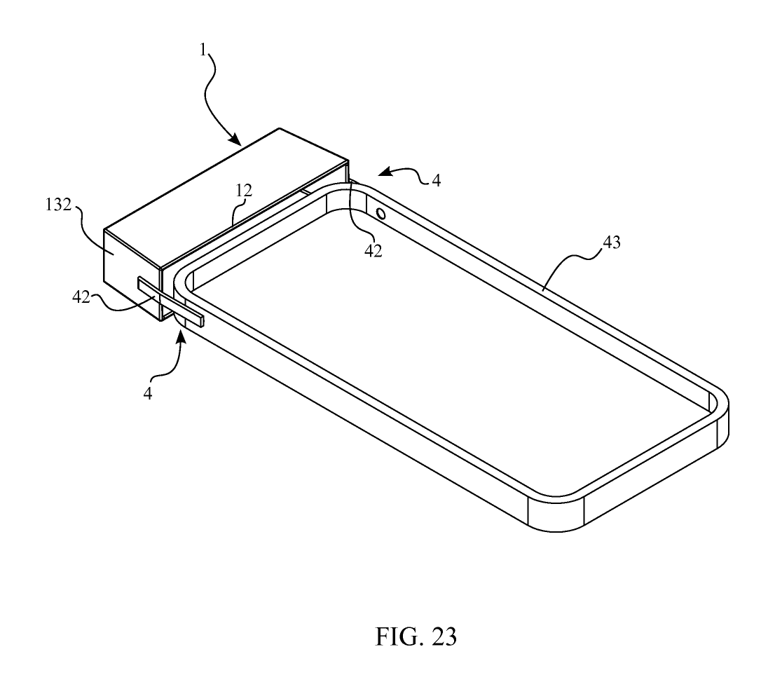

The attachment mechanism 4 of the second alternative embodiment further comprises a horizontal position and a vertical position. In reference to FIG. 23, the horizontal position securely places the radiation dissipation body 1 and linearly aligned with the lower position case 43 when the communication device is not used by the user.

When the user needs to use the communication device, the attachment mechanism 4 is changed from the horizontal position to the vertical position in order to attain the radiation dissipation distance 3 within the second alternative embodiment. In reference to FIG. 22, when the radiation dissipation body 1 is rotated 90 degrees clockwise and perpendicularly aligned with the lower position case 43, the second alternative embodiment is changed from the horizontal position into the vertical position. Since the vertical position firmly places the radiation dissipation body 1 perpendicular with the communication device, the speaker end is adjacently positioned around a speaker of the communication device. Once the attachment mechanism 4 of the second embodiment is at the horizontal position or the vertical position, the horizontal position and the vertical position are locked in place with the lower position case 43 and required extra pressure to change so that the radiation dissipation body 1 can be changed from one position to another.

Since different communication device manufactures require different manufacturer's suggested distances, the radiation dissipation distance 3 in the alternative embodiments can be varied, where the distance between the speaker side 12 and the ear side 11 are changed according to the manufacturer's suggested distances. When the alternative embodiments are used within a communication device, audio sounds from a communication device speaker are channeled through the audio passage 2 and the plurality of holes 113 to the user's ear. The radiation dissipation body 1 and the attachment mechanism 4 of the alternative embodiments prevent outside noise from getting into the audio passage 2 resulting improved audio sound quality. Since the ear side 11 of the alternative embodiments comfortably fits up against the user's ear, the audio passage 2 of the alternative embodiments provides a direct and clear path so that the audio sound can travel without any distortions. The radiation dissipation body 1 of the alternative embodiments can be made from plastic material but it is not limited to only to plastic material. The plastic material comprises a smooth outer layer so that the radiation dissipation body 1 can be easily cleaned for sanitary purposes. The smooth outer layer also keeps the radiation dissipation body 1 of the alternative embodiments clean without any buildups and germs.

Since all three embodiment of the present invention channel the sounds from the communication devices to the user's ear through the audio passage 2 while dissipating the emitting radiations, the present invention can functions as a hearing aid apparatus for elderly people or anyone who has a hearing problem.

Although the invention has been explained in relation to its preferred embodiment, it is to be understood that many other possible modifications and variations can be made without departing from the spirit and scope of the invention as hereinafter claimed.

What is claimed is:

1. An apparatus for the dissipation of emitting radiations from a communication device or any other radiation emitting devices by meeting or exceeding manufactures specifications comprises,
a radiation dissipation body;
an audio passage;
a radiation dissipation distance;
an attachment mechanism;
the radiation dissipation body comprises an ear side, a speaker side, and a lateral wall;
the ear side being oppositely positioned from the speaker side; and
the lateral wall being perimetrically positioned in between the ear side and the speaker side.

2. The apparatus for the dissipation of emitting radiations from a communication device or any other radiation emitting devices by meeting or exceeding manufactures specifications as claimed in claim 1 comprises,
the audio passage being concentrically traversed through the ear side to the speaker side, wherein the audio passage directly provides improved sound quality to a user.

3. The apparatus for the dissipation of emitting radiations from a communication device or any other radiation emitting devices by meeting or exceeding manufactures specifications as claimed in claim 1 comprises,
the radiation dissipation distance being extended from the ear side to the speaker side along the audio passage, wherein the radiation dissipation distance matches or exceeds manufactures specifications.

4. The apparatus for the dissipation of emitting radiations from a communication device or any other radiation emitting devices by meeting or exceeding manufactures specifications as claimed in claim 1 comprises,
the attachment mechanism comprises a first adhesive layer, a flexible middle layer, a second adhesive layer;
the first adhesive layer and the second adhesive layer being oppositely connected to the flexible middle layer;
the first adhesive layer being attached to the speaker side; and
the second adhesive layer being hermetically attached around a communication device speaker, wherein outside noise are kept out to improve the sound quality.

5. An apparatus for the dissipation of emitting radiations from a communication device or any other radiation emitting devices by meeting or exceeding manufactures specifications comprises,
a radiation dissipation body;
an audio passage;
a radiation dissipation distance;
an attachment mechanism;
the radiation dissipation body comprises an ear side, a speaker side, and lateral walls;
the lateral walls comprises a pair of elongated walls and a pair of compact walls;
the ear side being oppositely positioned from the speaker side;
the pair of compact walls being oppositely positioned of each other;
the pair of elongated walls being perpendicularly positioned with the pair of compact walls; and
the pair of compact walls and the pair of elongated walls being perimetrically connected to the ear side and the speaker side.

6. The apparatus for the dissipation of emitting radiations from a communication device or any other radiation emitting devices by meeting or exceeding manufactures specifications as claimed in claim 5 comprises,
the ear side comprises an exterior plane, an interior plane, and a plurality of holes;
the exterior plane being adjacently positioned within the pair of compact walls and the pair of elongated walls;
the interior plane being positioned parallel with the exterior plane and positioned in between the exterior plane and the speaker side;
the audio passage being traversed from the speaker side to the interior plane; and
the plurality of holes being traversed from the exterior plane to the interior plane and into the audio passage, wherein the audio passage directly provides improved sound quality to a user.

7. The apparatus for the dissipation of emitting radiations from a communication device or any other radiation emitting devices by meeting or exceeding manufactures specifications as claimed in claim 5 comprises,
the radiation dissipation distance being extended from the ear side to the speaker side, wherein the radiation dissipation distance matches or exceeds manufactures specifications.

8. The apparatus for the dissipation of emitting radiations from a communication device or any other radiation emitting devices by meeting or exceeding manufactures specifications as claimed in claim 5 comprises,
the attachment mechanism comprises a pair of tapered tracks, a lower position case, and a pair of track protrusions;
the pair of tapered tracks being oppositely positioned from each other and perpendicularly positioned with the speaker side;
the pair of tapered tracks being adjacently connected with the pair of compact walls;
the pair of track protrusions being oppositely positioned on the lower position case and aligned with the pair of tapered tracks;
the pair of track protrusions being perpendicularly connected to the lower position case, wherein the lower position case is partially placed around a communication device; and
the pair of track protrusions being movably and pivotally inserted into the pair of tapered tracks, wherein the attachment mechanism changes from a closed position to an opened position, a flip-up position, and a flip-up locked position.

9. The apparatus for the dissipation of emitting radiations from a communication device or any other radiation emitting devices by meeting or exceeding manufactures specifications as claimed in claim 5 comprises,
the attachment mechanism comprises a pair of extension arms and a lower position case;
the pair of extension arms being oppositely positioned on the lower position case;
the pair of extension arms being pivotally connected with the lower position case, wherein the lower position case is partially placed around a communication device;
the pair of extension arms being perpendicularly positioned with the speaker side; and
the pair of extension arms being adjacently connected the pair of compact walls.

10. An apparatus for the dissipation of emitting radiations from a communication device or any other radiation emitting devices by meeting or exceeding manufactures specifications comprises,
a radiation dissipation body;
an audio passage;
a radiation dissipation distance;
an attachment mechanism;
the radiation dissipation body comprises an ear side, a speaker side, and a lateral wall;
the ear side being oppositely positioned from the speaker side;
the lateral wall being perimetrically positioned in between the ear side and the speaker side;
the audio passage being concentrically traversed through the ear side to the speaker side, wherein the audio passage directly provides improved sound quality to a user; and
the radiation dissipation distance being extended from the ear side to the speaker side along the audio passage, wherein the radiation dissipation distance matches or exceeds manufactures specifications.

11. The apparatus for the dissipation of emitting radiations from a communication device or any other radiation emitting devices by meeting or exceeding manufactures specifications as claimed in claim 10 comprises,
the attachment mechanism comprises a first adhesive layer, a flexible middle layer, a second adhesive layer;
the first adhesive layer and the second adhesive layer being oppositely connected to the flexible middle layer;
the first adhesive layer being attached to the speaker side; and
the second adhesive layer being hermetically attached around a communication device speaker, wherein outside noise are kept out to improve the sound quality.
